(19) United States
(12) Patent Application Publication
(10) Pub. No.: US 2007/0013159 A1
(43) Pub. Date: Jan. 18, 2007

(54) Knuckle and bearing assembly and process of manufacturing same

(76) Inventor: Miquel Tuset Mestre, Barcelona (ES)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/387,604

(22) Filed: Mar. 23, 2006

Related U.S. Application Data
(60) Provisional application No. 60/664,468, filed on Mar. 23, 2005.

(51) Int. Cl. B62D 7/18; F16C 17/04; B21D 53/10

(52) U.S. Cl. 280/93.512; 384/420; 29/898.07

(57) ABSTRACT

A knuckle-bearing assembly for a vehicle comprises a knuckle having an aperture, a bearing press-fit into the aperture of the knuckle, and a plurality of hard particles mechanically deployed on the aperture or the bearing or both to increase a coefficient of friction between the knuckle and the bearing.

### CROSS-REFERENCE TO RELATED APPLICATION

This application claims priority from U.S. Provisional Patent Application No. 60/664,468 filed on Mar. 23, 2005, which is hereby incorporated by reference.

### FIELD OF THE INVENTION

The present invention relates generally to motor vehicle wheel end components, and more particularly, to a knuckle and bearing assembly and process for increasing the coefficient of friction between the knuckle and its corresponding bearing.

### BACKGROUND

Knuckle and bearing hub assemblies for vehicles receive forces and moments during running conditions that may provoke a movement of the bearing into the knuckle, especially when cornering or after an impact to the rim of the vehicle. As is known in the industry, bearing members may be press-fit into engagement with knuckle bores and therefore can shift in response to the above-identified external forces.

The prior art has attempted to reduce this movement through the use of adhesives and coatings or fixtures using bolts. Adhesive products increase the friction coefficient between the two surfaces but add a high quantity of extra material to the process and additional cost and labor. Further, the final quality of the product cannot be assured as the press-in force has no relation to press-out force. With coating products, some coating products may increase the friction coefficient. However, technologies to apply these processes are not mechanical but electronic and expensive to utilize. Special fixtures like bolts increase the material and labor cost and also increase the weight of the assembly.

Therefore, there is a need to prevent such movement of the bearing member within the knuckle bore to ensure that such outside forces do not damage the chassis arrangement.

### SUMMARY OF THE INVENTION

Accordingly, the present application discloses a knuckle-bearing assembly for a vehicle that comprises a knuckle having an aperture, a bearing press-fit into the aperture of the knuckle, and a plurality of hard particles mechanically deployed on the aperture or the bearing or both to increase a coefficient of friction between the knuckle and the bearing.

An alternative embodiment discloses a knuckle-bearing assembly that comprises a knuckle, an aperture located within the knuckle, the aperture having a surface, a bearing press-fit into the aperture, and a plurality of hard particles inlaid on the surface of the aperture increasing a coefficient of friction between the knuckle and the bearing.

In yet another embodiment, a method of assembly a knuckle-bearing for a vehicle comprises providing a knuckle having an aperture, inlaying a plurality of hard particles onto the aperture of the knuckle, and press-fitting a bearing into the aperture to increase a coefficient of friction between the knuckle and the bearing.

### BRIEF DESCRIPTION OF THE SEVERAL VIEWS OF THE DRAWING

The operation of the invention may be better understood by reference to the following detailed description taken in connection with the following illustrations, wherein:

FIG. 1 is a diagrammatical view of a knuckle aperture being sandblasted before press-fitting a bearing therein;

FIG. 2 is a diagrammatical view a bearing being press-fit within a treated knuckle aperture surface; and

FIG. 3 is a diagrammatical view of a knuckle and bearing assembly assembled.

### DETAILED DESCRIPTION OF THE INVENTION

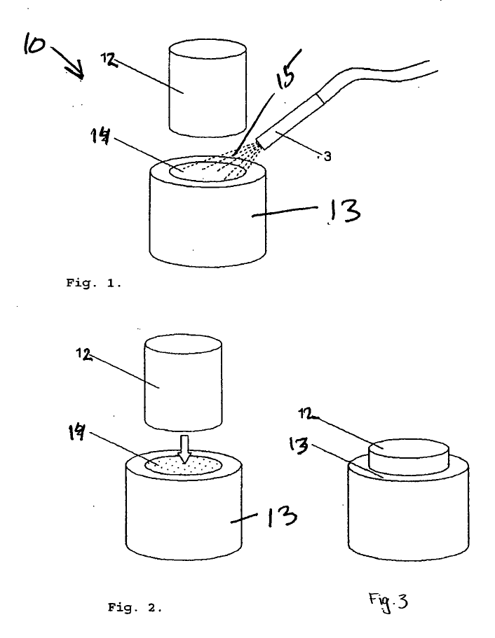

The present invention will now be described in accordance with the embodiment as shown in FIGS. 1 through 3. While this embodiment is described with reference to a knuckle-bearing assembly for vehicles, it should be clear that the present invention can be used with any press-fit arrangement.

The embodiment of FIGS. 1, 2, and 3 provides a knuckle and bearing assembly and process of manufacturing the same wherein the coefficient of friction is increased between the knuckle and its corresponding bearing to reduce the slippage or movement of the bearing related to the knuckle bore under running vehicle conditions. Further, the present embodiment increases the coefficient of friction without using extra fixtures or significantly increasing the interference.

A knuckle and bearing assembly 10 is shown in FIG. 3. More specifically, as shown in FIG. 1, the knuckle and bearing assembly 10 comprises a bearing 12 and a knuckle 13. The knuckle 13 includes an aperture 14 in it wherein the aperture 14 includes a surface 16. The bearing 12 likewise includes an outer surface 17. As show in FIG. 2, the knuckle and bearing assembly 10 is assembled by press-fitting the bearing 12 into the aperture 14 of the knuckle 13 such that the surface 16 of the aperture 14 of the knuckle 13 contacts the outer surface 17 of the bearing 12. Accordingly, the aperture 14 is of a shape and size that the bearing 12 fits tightly in the aperture 14 to create the press-fit.

The knuckle and bearing assembly 10 increases the coefficient of friction between the knuckle 13 and the bearing 12 through application of a treatment process. As shown in FIG. 1, the aperture 14 has hard particles 15 mechanically deployed thereon before press-fitting the bearing 12 into the aperture 14. More specifically, the aperture has hard particles 15 inlaid thereon before press-fitting the bearing 12 into the aperture 14. Alternatively, the bearing 12 or both the bearing 12 and the aperture 14 can have hard particles 15 mechanically deployed, or more specifically, inlaid, before press fitting to achieve the same result.

When the hard particles 15 are inlaid into the aperture 14, the bearing 12, or both. More specifically, the hard particles 15 are sandblasted onto the surface 16 of the aperture 14 of the knuckle 13, the outer surface 17 of the bearing, or both surfaces. The hard particles 15 remain inlaid on these surfaces. While numerous other hard particles could be utilized, it is presently preferred that Corindon be used. Therefore, as shown in FIG. 2, the bearing 12 can be press-fit into the aperture 14 of the knuckle 13 to form the knuckle and bearing assembly 10 shown in FIG. 3. As such, the press-in force to assemble the bearing 12 into the aperture 14 of the knuckle 13 is higher, as the hard particles 15 have increased the friction coefficient between both surfaces 16, 17 of the knuckle 13 and the bearing 12. The press-out force to disassemble the bearing 12 from the knuckle 13 is then also higher due to hard particles 15 inlaid in the sandblasted surface or surfaces 16, 17.

The present is technologically easy to implement, as the hard particles 15 are mechanically deployed on the surfaces 16, 17. The performance of the process can be controlled by measuring the press-in force. The friction coefficient can be adjusted through the sandblasting parameters. Numerous parameters of the sandblasting process can be adjusted to affect the performance of the process and the resultant coefficient of friction. For example, the following parameters cab be adjusted: material of the particles (e.g., Corindon), application distance (e.g., lower than 150 mm), air pressure (e.g., about 6 bar), application time (e.g., about 20 seconds), density of hard particles into the air (e.g., about 2 mg/m³) and dimension of particles 15 (e.g., about 80 FEPA—diameter of 0.17 up to 0.21 mm). In such a process, the coefficient of friction increases approximately 50%.

For example, the required force to remove a bearing out of a knuckle with a certain fit in the prior art is between 35 kN and 40 kN. Utilizing the knuckle and bearing assembly 10, this required force can be increased to between 50 and 170 kN, depending on the parameters of the process. This has a direct affect on the bearing movement in the knuckle bore under cornering conditions and also when there are impacts to the rim. For example, the movement of the bearing in the knuckle bore of the prior art, under certain cornering conditions, is 0.3 mm. Utilizing knuckle and bearing assembly 10 (force to remove the bearing 12 out of the knuckle 13 is approximately 60 kN) the movement of the bearing 12 in the same conditions is 0.035 mm. The movement of the bearing 12 in the knuckle aperture of the prior art, under certain impact to the rim conditions, is 0.45 mm. Utilizing the knuckle and bearing assembly 10 (force to remove the bearing 12 out of the knuckle 13 is 170 kN) the movement of the bearing 12 under the same conditions is 0.01 mm. Thus, the push-in/push-out loads are greatly increased, without increasing press-fit (which reduces life of bearing and increases friction/rolling resistance). With the increased push-in/push-out loads, the bearing retention is greatly improved and the reduced bearing movement under cornering/curb-impact loads helps maintain AntiLock Braking Signal functions.

Although the preferred embodiment of the present invention has been illustrated in the accompanying drawings and described in the foregoing detailed description, it is to be understood that the present invention is not to be limited to just the preferred embodiment disclosed, but that the invention described herein is capable of numerous rearrangements, modifications and substitutions without departing from the scope of the claims hereafter.

Having thus described the invention, I claim:

1. A knuckle-bearing assembly for a vehicle comprising:
a knuckle having an aperture;
a bearing press-fit into said aperture of said knuckle; and
a plurality of hard particles mechanically deployed on said aperture or said bearing or both to increase a coefficient of friction between said knuckle and said bearing.

2. The knuckle-bearing assembly of claim 1, wherein said hard particles mechanically deployed on said aperture or said bearing or both comprises said hard particles being inlaid on said aperture or said bearing or both.

3. The knuckle-bearing assembly of claim 2, wherein said hard particles inlaid on said aperture or said bearing or both reduce movement of said bearing relative to said knuckle under running conditions of said vehicle.

4. The knuckle-bearing assembly of claim 3, wherein movement of said bearing relative to said knuckle under running conditions of said vehicle is reduced to approximately between 0.01 mm to 0.035 mm.

5. The knuckle-bearing assembly of claim 3, wherein said hard particles inlaid on said aperture or said bearing or both result in a higher press-in force to press-fit said bearing into said knuckle.

6. The knuckle-bearing assembly of claim 5, wherein said hard particles inlaid on said aperture or said bearing or both result in a higher press-out force to disassemble said bearing from said knuckle aperture.

7. The knuckle-bearing assembly of claim 6, wherein said press-in force to press-fit said bearing into said knuckle and said press-out force to disassemble said bearing from said knuckle aperture is approximately between 50 kN and 170 kN.

8. The knuckle-bearing assembly of claim 7, wherein said hard particles are inlaid by sandblasting.

9. A knuckle-bearing assembly comprising:
a knuckle;
an aperture located within said knuckle, said aperture having a surface;
a bearing press-fit into said aperture; and
a plurality of hard particles inlaid on said surface of said aperture increasing a coefficient of friction between said knuckle and said bearing.

10. The knuckle-bearing assembly of claim 9, wherein said hard particles inlaid on said surface of said aperture of said knuckle reduces movement of said bearing relative to said knuckle.

11. The knuckle-bearing assembly of claim 10, wherein said bearing further comprises an outer surface, said outer surface having a plurality of hard particles inlaid thereon.

12. The knuckle-bearing assembly of claim 11, wherein said hard particles are Corindon.

13. The knuckle-bearing assembly of claim 12, wherein said inlaid hard particles are sandblasted onto said surface of said aperture and said outer surface of said bearing.

14. A method of assembly a knuckle-bearing for a vehicle comprising:
providing a knuckle having an aperture;
inlaying a plurality of hard particles onto said aperture of said knuckle; and
press-fitting a bearing into said aperture to increase a coefficient of friction between said knuckle and said bearing.

15. The method of claim 14, wherein inlaying said plurality of hard particles onto said aperture of said knuckle comprises sandblasting said plurality of hard particles onto a surface of said aperture of said knuckle.

16. The method of claim 15, further comprising sandblasting a plurality of hard particles onto an outer surface of said bearing.

17. The method of claim 16, further comprising adjusting force required to press-fit said bearing into said aperture to control said coefficient of friction to reduce slippage or movement of said bearing related to said aperture during running conditions of said vehicle.

18. The method of claim 17, further comprising controlling said coefficient of friction between said bearing and said aperture during press-fitting through adjusting parameters of sandblasting said hard particles.

19. The method of claim 18, wherein at least one of said parameters comprises: material of said hard particles, application distance, air pressure, application time, density of hard particles into air, and dimension of hard particles.

20. The method of claim 19, wherein said parameters comprise: said material of said hard particles being Corindon, said application distance being less than 150 mm, said air pressure being approximately 6 bar, said application time being approximately 20 seconds, said density of said hard particles into air being approximately 2 mg/m³, and said dimension of said hard particles being a diameter of between 0.17 mm and 0.21 mm.
